(19) United States
(12) Patent Application Publication
(10) Pub. No.: US 2022/0091691 A1
(43) Pub. Date: Mar. 24, 2022

(54) PUSHING DETECTION DEVICE FOR TOUCH PANEL, ELECTRONIC DEVICE, AND PUSHING DETECTION METHOD FOR TOUCH PANEL

(71) Applicant: MITSUBISHI ELECTRIC CORPORATION, Tokyo (JP)

(72) Inventors: Fuqiang HAN, Tokyo (JP); Kento HIGASHITSUTSUMI, Tokyo (JP)

(73) Assignee: MITSUBISHI ELECTRIC CORPORATION, Tokyo (JP)

(21) Appl. No.: 17/420,267

(22) PCT Filed: Feb. 8, 2019
(86) PCT No.: PCT/JP2019/004644

§ 371 Date: Jul. 1, 2021

(51) Int. Cl. G06F 3/041

(52) U.S. Cl. CPC G06F 3/0414; G06F 3/0412; G06F 3/0416

(57) ABSTRACT

A movement amount calculation unit for integrating, over a movement amount collection time period, a movement amount of a coil unit when the coil unit moves, the movement amount being calculated on the basis of an electromotive force occurring in the coil unit as the coil unit moves, to thereby calculate a movement amount for determination of the coil unit, and a pushing determination unit for determining the existence or nonexistence of a pushing operation by using the movement amount for determination calculated by the movement amount calculation unit are included.

### TECHNICAL FIELD

The present disclosure relates to a pushing detection device for touch panel that detects a pushing operation on a touch panel.

### BACKGROUND ART

Conventionally, devices that detect a user's pressing operation on a touch panel are known. For example, an input device disclosed in Patent Literature 1 detects a pressing operation by using a voice coil which is disposed in a magnetic circuit, and which is for providing users with a tactile feedback. Concretely, when an electromotive force occurs in the voice coil through a press of a touch panel, the input device outputs a press signal and detects whether a user has performed a pressing operation on the touch panel on the basis of the press signal.

### CITATION LIST

### Patent Literature

Patent Literature 1: WO No. 2012/169138

### SUMMARY OF INVENTION

### Technical Problem

In conventional technologies typified by the technology of the input device disclosed in Patent Literature 1, even when the occurrence of an electromotive force is instantaneous, this occurrence is detected as a pressing operation. Therefore, in the conventional technologies, also when, for example, the touch panel is instantaneously pressed because of a non-intended user's touch of the touch panel, the press may be detected erroneously as a pressing operation. More specifically, a problem with the conventional technologies is that there are cases in which a pressing operation on the touch panel is erroneously detected.

The present disclosure is made in order to solve the above-mentioned problem, and it is therefore an object of the present disclosure to provide a pushing detection device for touch panel that can prevent the erroneous detection of a pushing operation on a touch panel.

### Solution to Problem

According to the present disclosure, there is provided a pushing detection device for touch panel, for detecting a pushing operation on a touch panel in an electronic device which includes the touch panel, a body chassis, and at least one voice coil actuator for vibrating the touch panel, the voice coil actuator having a coil unit fixed to the touch panel and a magnetic circuit unit fixed to the body chassis, and in which the touch panel and the coil unit move relatively to the body chassis through the pushing operation on the touch panel, the pushing detection device including: a movement amount calculation unit for integrating, over a movement amount collection time period, a movement amount of the coil unit when the coil unit moves, the movement amount being calculated on the basis of an electromotive force occurring in the coil unit as the coil unit moves, to thereby calculate a movement amount for determination of the coil unit; and a pushing determination unit for determining the existence or nonexistence of the pushing operation by using the movement amount for determination calculated by the movement amount calculation unit.

### Advantageous Effects of Invention

According to the present disclosure, the erroneous detection of a pushing operation on the touch panel can be prevented.

### BRIEF DESCRIPTION OF DRAWINGS

FIG. 1 is a front view of an electronic device according to Embodiment 1;

FIG. 2 is a cross-sectional arrow view of FIG. 1 taken along the line II-II;

FIG. 3 is a cross-sectional arrow view of FIG. 1 taken along the line III-III;

FIG. 4 is a diagram showing an example of the configuration of a pushing detection device according to Embodiment 1;

FIG. 5 is a diagram for explaining an electromotive force occurring in a coil, a magnetic flux density in a magnetic gap, and a direction in which the moving speed of a coil unit occurs, when the coil unit moves in Embodiment 1;

FIG. 6 is a diagram showing an example of a movement amount for integration and a movement amount for determination which are calculated by a movement amount calculation unit in Embodiment 1;

FIGS. 7A and 7B are diagrams for explaining a concept of the determination in Embodiment 1 of whether or not a push of a touch panel is caused by a user's pushing operation, the determination being performed by a pushing determination unit using the movement amount for determination calculated by the movement amount calculation unit, FIG. 7A shows a concept of the movement amount for integration which varies with time when a push of the touch panel occurs through a user's pushing operation, and FIG. 7B shows a concept of the movement amount for integration which varies with time when there occurs a push of the touch panel which is not caused by a user's pushing operation;

FIG. 8 is a flowchart for explaining the operation of the pushing detection device according to Embodiment 1;

FIG. 9 is a diagram showing an example of the configuration of an electronic device in Embodiment 1 which is adapted to include multiple voice coil actuators;

FIGS. 10A and 10B are diagrams for explaining a concept of the movement amount for determination which the pushing detection device calculates in the case where the electronic device is the one as shown in FIG. 9 and where a push of the touch panel occurs at a push position in Embodiment 1, FIG. 10A shows a concept of the movement amount for integration of the coil unit in a first voice coil actuator which varies with time when a push of the touch panel occurs at the push position, and FIG. 10B shows a concept of the movement amount for integration of the coil unit in a fourth voice coil actuator which varies with time when a push of the touch panel occurs at the push position; and

FIGS. 11A and 11B are diagrams showing examples of the hardware configuration of the pushing detection device according to Embodiment 1.

### DESCRIPTION OF EMBODIMENTS

Hereinafter, an embodiment of the present disclosure will be explained in detail with reference to the drawings. Embodiment 1.

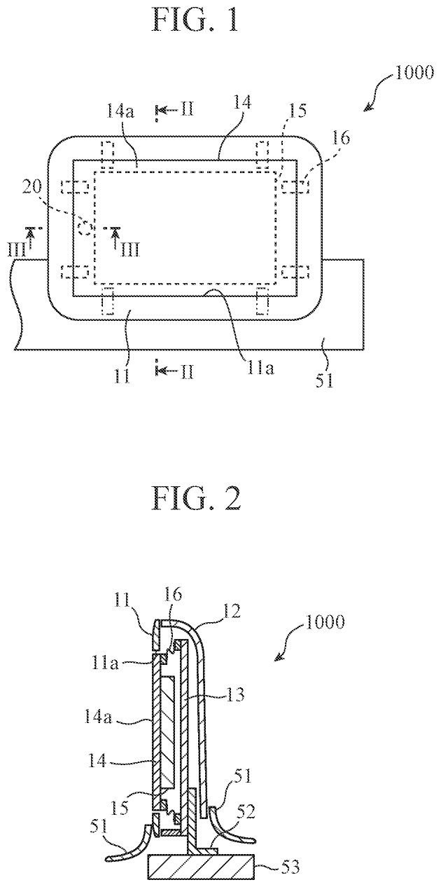

FIGS. 1 to 3 are diagrams for explaining the configuration of an electronic device 1000 according to Embodiment 1.

The electronic device 1000 according to Embodiment 1 is, for example, a vehicle-mounted device installed in a vehicle. As will be mentioned later, the electronic device 1000 includes a body chassis 13 and a touch panel 14, and the touch panel 14 is supported in such a way as to be able to move relatively to the body chassis 13. Users can perform an operation of pushing the touch panel 14 (referred to as a “pushing operation” hereinafter) as needed when using the electronic device 1000. When a user performs a pushing operation on the touch panel 14, the touch panel 14 moves relatively to the body chassis 13. The electronic device 1000 includes a pushing detection device 100 that detects a user's pushing operation on the touch panel 14. In FIGS. 1 to 3, illustration of the pushing detection device 100 is omitted. The details of the pushing detection device 100 will be mentioned later.

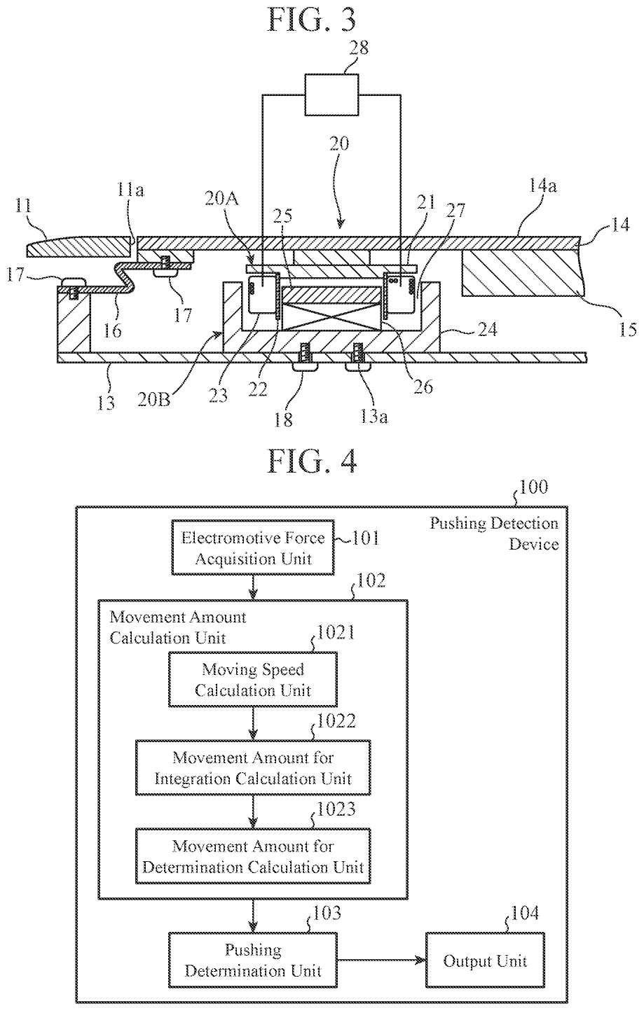

FIG. 1 is a front view of the electronic device 1000 according to Embodiment 1, FIG. 2 is a cross-sectional arrow view of FIG. 1 taken along the line II-II, and FIG. 3 is a cross-sectional arrow view of FIG. 1 taken along the line III-III.

In Embodiment 1, a side of the electronic device 1000 facing the rear of the vehicle in a state where the electronic device is installed in the vehicle is referred to as a “front side.” FIG. 1 is a front view of the electronic device 1000 when viewed from the front side. Further, in Embodiment 1, the other side of the electronic device 1000 opposite to the front side and facing the front of the vehicle in the state where the electronic device is installed in the vehicle is referred to as a “rear side.”

As shown in FIGS. 1 to 3, the electronic device 1000 according to Embodiment 1 includes a front side design panel 11, a rear side design panel 12, the body chassis 13, the touch panel 14, a liquid crystal panel 15, springs 16, and a voice coil actuator 20.

In the cabin of the vehicle, a vehicle panel 51, amounting plate 52, and a vehicle side fixed portion 53 are disposed.

The front side design panel 11 and the rear side design panel 12 constitute an outer shell of the electronic device 1000, and are joined to each other.

The front side design panel 11 is disposed on the front side of the electronic device 1000, and has a substantially rectangular frame shape. The front side design panel 11 has an opening 11a having a substantially rectangular shape.

The rear side design panel 12 is disposed on the rear side of the electronic device 1000, and has a substantially rectangular plate shape. A lower edge portion of the front side design panel 11 and a lower edge portion of the rear side design panel 12 are covered by the vehicle panel 51 from outer sides of both the lower edge portions, and are fixed to the vehicle panel 51.

The body chassis 13, the liquid crystal panel 15, the springs 16, and the voice coil actuator 20 are disposed in an internal space formed by joining the front side design panel 11 and the rear side design panel 12. The touch panel 14 is disposed in a space defined by the opening 11a of the front side design panel 11. The body chassis 13 is fixed to the vehicle side fixed portion 53 via the mounting plate 52. Although in Embodiment 1 the body chassis 13 and each of the other components of the electronic device 1000 are disposed as separate components, this is only an example. The body chassis 13 has only to support the touch panel 14 in such a way that the touch panel can move relatively to the body chassis 13, and may be disposed integrally with anyone of the other components of the electronic device 1000 to also serve the function thereof.

Both the touch panel 14 and the liquid crystal panel 15 have a substantially rectangular shape when viewed from the front side. When viewed from the front side, the touch panel 14 is larger than the liquid crystal panel 15.

A rear surface of the touch panel 14 and a front surface of the liquid crystal panel 15 are bonded together. In Embodiment 1, a surface on the front side of each of the components which constitute the electronic device 1000 is referred to as a “front surface”, and a surface on the rear side of each of the components is referred to as a “rear surface.”

The touch panel 14 and the liquid crystal panel 15 are bonded together in such a way that the liquid crystal panel 15 is positioned at a substantially center portion of the touch panel 14. Therefore, the liquid crystal panel 15 is not present in an outer peripheral portion on the rear surface of the touch panel 14.

The touch panel 14 is disposed in the space defined by the opening 11a of the front side design panel 11 in a state where the touch panel is bonded to the liquid crystal panel 15. A front surface of the touch panel 14 is exposed from the opening 11a of the front side design panel 11 and is directed toward the front side, and constitutes an operation surface 14a. The operation surface 14a receives either a touch operation from a user or a pushing operation on the touch panel from a user.

The springs 16 are disposed at multiple positions between a front surface of the body chassis 13 and the outer peripheral portion on the rear surface of the touch panel 14. Each spring 16 is, for example, a flat spring of bent shape having a first end and a second end. The first end of each spring 16 is fixed to the front surface of the body chassis 13 using a screw 17. The second end of each spring 16 is fixed to the outer peripheral portion on the rear surface of the touch panel 14 using a screw 17. Using the elastic forces of the springs 16, the touch panel 14 is supported in such a way as to be able to move relatively to the body chassis 13. In other words, the touch panel 14 is in a state of floating with respect to the body chassis 13. In a state where the touch panel 14 is not pushed (referred to as an “initial state” hereinafter), the touch panel 14 is substantially standing still at a predetermined relative position (referred to as an “initial position” hereinafter) with respect to the body chassis 13.

Although in Embodiment 1 it is assumed that the touch panel 14 is supported using the springs 16 in such a way as to be able to move relatively to the body chassis 13, this is only an example. For example, the touch panel 14 may be supported using elastic members other than the springs 16 in such a way as to be able to move relatively to the body chassis 13, and the touch panel 14 has only to be supported in such a way as to be able to move relatively to the body chassis 13.

The voice coil actuator 20 is an actuator for vibrating the touch panel 14, and one or more voice coil actuators are disposed between the front surface of the body chassis 13 and the outer peripheral portion on the rear surface of the touch panel 14.

In FIGS. 1 and 3, the case in which only the single voice coil actuator 20 is disposed on the rear surface of the touch panel 14 is shown as an example.

The voice coil actuator 20 has a coil unit 20A and a magnetic circuit unit 20B. The outer shapes of the coil unit 20A and the magnetic circuit unit 20B are, for example, substantially circular ones. The coil unit 20A and the magnetic circuit unit 20B are arranged substantially coaxially. The coil unit 20A is fixed to the outer peripheral portion on the rear surface of the touch panel 14. On the other hand, the magnetic circuit unit 20B is fixed to the front surface of the body chassis 13.

The coil unit 20A has a pusher 21, a coil bobbin 22, and a coil 23. A voltage measurement circuit 28 is connected to the coil 23.

The pusher 21 is a member for transmitting a force to the rear surface of the touch panel 14 when the voice coil actuator 20 operates. A front surface of the pusher 21 is fixed to the rear surface of the touch panel 14. The outer shape of the pusher 21 is, for example, a substantially circular one.

The coil bobbin 22 is fixed to a rear surface of the pusher 21. The coil bobbin 22 is substantially cylindrical. The coil 23 serves as a source of vibration in the voice coil actuator 20, and is wound around an outer surface of the coil bobbin 22.

The magnetic circuit unit 20B has a yoke 24, a pole 25, and a magnet 26. The yoke 24 and the pole 25 are each made of a magnetic material.

The yoke 24 includes a bottom plate portion having a substantially circular shape, and a cylindrical portion. The bottom plate portion of the yoke 24 is fixed to the front surface of the body chassis 13 using screws 18. Each screw 18 penetrates a through hole 13a formed in the body chassis 13 from a rear surface of the body chassis 13, and fastens the bottom plate portion of the yoke 24 and the body chassis 13 to each other.

The pole 25 and the magnet 26 are disposed in the internal space of the cylindrical portion of the yoke 24. The outer shapes of the pole 25 and the magnet 26 are, for example, substantially circular ones. The pole 25 and the magnet 26 are arranged in such a way as to be stacked substantially coaxially. The magnet 26 is disposed on a bottom surface in the internal space of the cylindrical portion of the yoke 24, and the pole 25 is disposed on a front surface of the magnet 26. The outer diameter of the pole 25 is equal to or greater than the outer diameter of the magnet 26.

A substantially ring-shaped magnetic gap 27 is formed by space between an inner surface of the cylindrical portion of the yoke 24 and an outer surface of the pole 25. The coil 23 wound around the outer surface of the coil bobbin 22 is disposed in the magnetic gap 27. By disposing the coil 23 in the magnetic gap 27, the magnet 26 is disposed inside the coil 23. The voice coil actuator 20 is of so-called inner magnet type having the configuration in which the magnet 26 is disposed inside the coil 23.

Both the coil 23 and the coil bobbin 22 of the voice coil actuator 20 vibrate in a direction of the axis of the coil unit 20A integrally with each other because of the interaction between an oscillating current supplied to the coil 23 and a magnetic flux flowing inside the magnetic gap 27 from the pole 25 to the yoke 24. More concretely, for example, when a not-illustrated control device detects a touch operation on the touch panel 14, an oscillating current is supplied to the voice coil actuator 20. When the oscillating current is supplied, the coil unit 20A of the voice coil actuator 20 vibrates in response to the oscillating current.

The vibration caused by the voice coil actuator 20 is propagated to the touch panel 14. As a result, the touch panel 14 vibrates.

A gap having a predetermined width is provided between the rear surface of the pusher 21 and a front surface of the pole 25. This gap is wide to the extent that the rear surface of the pusher 21 and the front surface of the pole 25 do not come into contact with each other even when the coil unit 20A vibrates.

In Embodiment 1, the front side design panel 11, the rear side design panel 12, the body chassis 13, and the magnetic circuit unit 20B, which are components which do not move relatively to the vehicle side fixed portion 53, out of the components which constitute the electronic device 1000 are also referred to collectively as a fixed unit.

Further, in Embodiment 1, the touch panel 14, the liquid crystal panel 15, and the coil unit 20A, which are components which can move relatively to the fixed unit, out of the components which constitute the electronic device 1000 are also referred to collectively as a movable unit.

In the voice coil actuator 20, the voltage measurement circuit 28 is connected to the coil 23.

The voltage measurement circuit 28 measures an electromotive force (e[V]) occurring in the coil 23 in the coil unit 20A.

In the electronic device 1000, when, for example, a load in a pushing direction is applied to the touch panel 14 in the initial state where the touch panel 14 is at the initial position, the movable unit moves relatively to the fixed unit. The fact that the movable unit moves relatively to the fixed unit means that the touch panel 14 and the coil unit 20A move relatively to the body chassis 13. At this time, because the coil 23 passes in such a way as to cross a magnetic circuit formed by the magnetic circuit unit 20B, an electromotive force occurs in the coil 23. The voltage measurement circuit 28 measures the electromotive force occurring in the coil 23. It is assumed that the voltage measurement circuit 28 measures the electromotive force at all times.

The pushing detection device 100 which will be mentioned later detects a user's pushing operation on the touch panel 14 on the basis of the electromotive force measured by the voltage measurement circuit 28.

The pushing detection device 100 according to Embodiment 1 will be explained. The electronic device 1000 includes the pushing detection device 100 as mentioned above, though illustration thereof is omitted in FIGS. 1 to 3. The pushing detection device 100 includes, for example, a CPU, a memory, and so on which the electronic device 1000 includes.

When a push of the touch panel 14 occurs in the electronic device 1000, in other words, when an electromotive force occurs in the coil 23, the pushing detection device 100 determines whether or not the push is caused by a user's pushing operation on the touch panel 14.

FIG. 4 is a diagram showing an example of the configuration of the pushing detection device 100 according to Embodiment 1.

The pushing detection device 100 includes an electromotive force acquisition unit 101, a movement amount calculation unit 102, a pushing determination unit 103, and an output unit 104.

The movement amount calculation unit 102 includes a moving speed calculation unit 1021, a movement amount for integration calculation unit 1022, and a movement amount for determination calculation unit 1023.

The electromotive force acquisition unit 101 acquires information about the electromotive force measured by the voltage measurement circuit 28. Every time the measurement of an electromotive force is made, the electromotive force acquisition unit 101 acquires information about the electromotive force measured by the voltage measurement circuit 28. In Embodiment 1, it is assumed that the acquisition of the information by the electromotive force acquisition unit 101 which is made every time the measurement of an electromotive force is made is performed at all times.

The electromotive force acquisition unit 101 outputs the acquired information about the electromotive force to the movement amount calculation unit 102.

The movement amount calculation unit 102 integrates, over a movement amount collection time period, the movement amount of the coil unit 20A when the coil unit 20A moves, the movement amount being calculated on the basis of an electromotive force which occurs in the coil 23 in the coil unit 20A as the coil unit 20A moves, to thereby calculate a movement amount for determination of the coil unit 20A.

Concretely, the movement amount calculation unit 102 calculates the moving speed of the coil unit 20A when a push occurs on the touch panel 14, on the basis of the information about an electromotive force, the information being acquired by the electromotive force acquisition unit 101. For example, the moving speed of the coil unit 20A is assumed to have a positive value when the coil unit 20A moves in a pushing direction. In Embodiment 1, the “integration” may be an arithmetic operation other than integration in the strict mathematical sense, and, for example, also includes adding up of discrete values.

Next, the movement amount calculation unit 102 calculates the movement amount when the coil unit 20A moves from the initial position (referred to as a “movement amount for integration” hereinafter) on the basis of the moving speed. For example, the movement amount of the coil unit 20A is assumed to have a positive value when the coil unit 20A moves in a pushing direction with respect to the initial position. The movement amount calculation unit 102 further calculates a movement amount which is the result of integrating the movement amounts for integration over a preset period of time (referred to as a “movement amount for determination” hereinafter). The movement amount calculation unit 102 determines whether or not a push of the touch panel 14 is caused by a user's pushing operation on the touch panel 14, on the basis of the movement amount for determination, thereby detecting the pushing operation. In Embodiment 1, the period of time which is preset as the collection time period of the movement amounts for integration for calculating the movement amount for determination is also referred to as a “movement amount collection time period.”

The moving speed calculation unit 1021 calculates the moving speed of the coil unit 20A when the coil unit 20A moves, on the basis of the information about an electromotive force, the information being acquired by the electromotive force acquisition unit 101.

When a load is applied to the touch panel 14, thereby the movable unit moves, and thereby the coil unit 20A included in the movable unit moves, an electromotive force (e) occurs in the coil 23. The electromotive force in this case is given by the following equation (1), on the basis of Fleming's right-hand rule.

e=BLv sin θ[V] (1)

B: the magnetic flux density in the magnetic gap 27, L: the coil wire length of the coil 23, v: the moving speed of the coil unit 20A, and θ: the angle between the direction of the magnetic flux in the magnetic gap 27 and the direction of movement of the coil unit 20A.

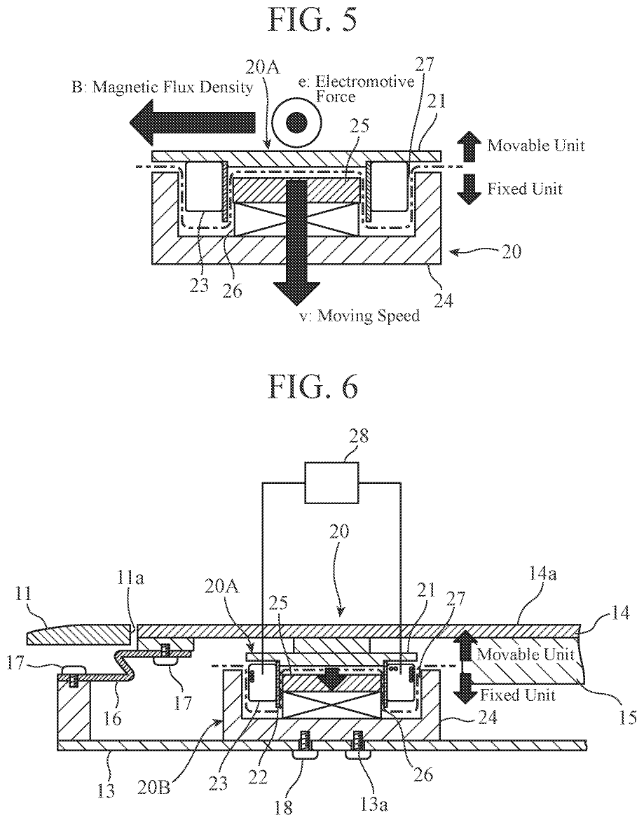

FIG. 5 is a diagram for explaining the electromotive force occurring in the coil 23, the magnetic flux density in the magnetic gap 27, and the direction in which the moving speed of the coil unit 20A occurs, when the coil unit 20A moves in Embodiment 1.

The magnetic flux density in the magnetic gap 27 and the coil wire length of the coil 23 are acquired from the specifications of the voice coil actuator 20. The angle (θ) between the direction of the magnetic flux in the magnetic gap 27 and the direction of movement of the coil unit 20A is 90 degrees. Therefore, when a measured value of the electromotive force can be acquired, the moving speed calculation unit 1021 can calculate the moving speed of the coil unit 20A when a push occurs on the touch panel 14, on the basis of the measured value of the electromotive force.

The moving speed calculation unit 1021 outputs information about the calculated moving speed to the movement amount for integration calculation unit 1022 of the movement amount calculation unit 102.

The movement amount for integration calculation unit 1022 integrates the moving speed calculated by the moving speed calculation unit 1021, to calculate the movement amount of the coil unit 20A as a movement amount for integration. The movement amount for integration calculation unit 1022 calculates the movement amount for integration at every predetermined time. For example, every time the information about the moving speed is outputted from the moving speed calculation unit 1021, the movement amount for integration calculation unit 1022 calculates the movement amount for integration.

The movement amount for integration calculation unit 1022 causes the calculated movement amount for integration to be temporarily stored in an area to which the movement amount calculation unit 102 can refer. In Embodiment 1, it is assumed that, as an example, the movement amount for integration calculation unit 1022 causes the calculated movement amount to be temporarily stored in a not-illustrated memory which the pushing detection device 100 includes.

The movement amount for integration calculation unit 1022 repeats the calculation of the movement amount for integration and the temporary storage of the movement amount for integration until the movement amounts for integration collected over the movement amount collection time period are temporarily stored.

The movement amount for determination calculation unit 1023 integrates, over the movement amount collection time period, the movement amounts for integration calculated by the movement amount for integration calculation unit 1022, to calculate the movement amount for determination. Concretely, the movement amount for determination calculation unit 1023 determines whether the movement amount collection time period has elapsed. When it is determined that the movement amount collection time period has elapsed, the movement amount for determination calculation unit 1023 acquires the movement amounts for integration which are caused to be temporarily stored by the movement amount for integration calculation unit 1022, and integrates the movement amounts for integration over the movement amount collection time period, thereby calculating the movement amount for determination.

The movement amount calculation unit 102 deletes the movement amounts for integration which are caused to be temporarily stored by the movement amount for integration calculation unit 1022 every time the movement amount for determination is calculated or when the power of the pushing detection device 100 is switched off. The movement amount calculation unit 102 can determine whether the movement amount collection time period has elapsed, on the basis of, for example, the time when the first one of the movement amounts for integration temporarily stored in chronological order is calculated. When the movement amount for integration is calculated, information about the time when the movement amount for integration is calculated is stored by the movement amount calculation unit 102 in, for example, a not-illustrated memory of the pushing detection device 100 while the information about the time is brought into correspondence with information about the calculated movement amount for integration.

The movement amount for determination calculation unit 1023 outputs the calculated movement amount for determination to the pushing determination unit 103.

FIG. 6 is a diagram showing an example of the movement amount for integration and the movement amount for determination which are calculated by the movement amount calculation unit 102 in Embodiment 1.

The pushing determination unit 103 determines whether or not a push occurring on the touch panel 14 is caused by a pushing operation, by using the movement amount for determination calculated by the movement amount for determination calculation unit 1023 of the movement amount calculation unit 102, to detect a pushing operation on the basis of a result of the determination.

Concretely, the pushing determination unit 103 determines whether or not the movement amount for determination outputted from the movement amount for determination calculation unit 1023 is equal to or greater than a preset threshold (referred to as a “threshold for pushing determination” hereinafter). The threshold for pushing determination is preset and is stored at an area to which the pushing determination unit 103 can refer. For example, the threshold for pushing determination is set to a minimum value of the movement amount for determination which is to be acquired when the touch panel 14 is pushed through a user's pushing operation on the touch panel 14. A user or the like can set up or change the threshold for pushing determination as appropriate.

When determining that the movement amount for determination is equal to or greater than the threshold for pushing determination, the pushing determination unit 103 determines that the push of the touch panel 14 is caused by a pushing operation, and thereby detects the pushing operation.

When determining that the movement amount for determination is less than the threshold for pushing determination, the pushing determination unit 103 determines that the push of the touch panel 14 is not caused by a pushing operation. More specifically, when the pushing determination unit 103 determines that the movement amount for determination is less than the threshold for pushing determination, no pushing operation is detected.

When detecting a pushing operation, the pushing determination unit 103 outputs pushing detection information notifying that this pushing operation has been detected to the output unit 104.

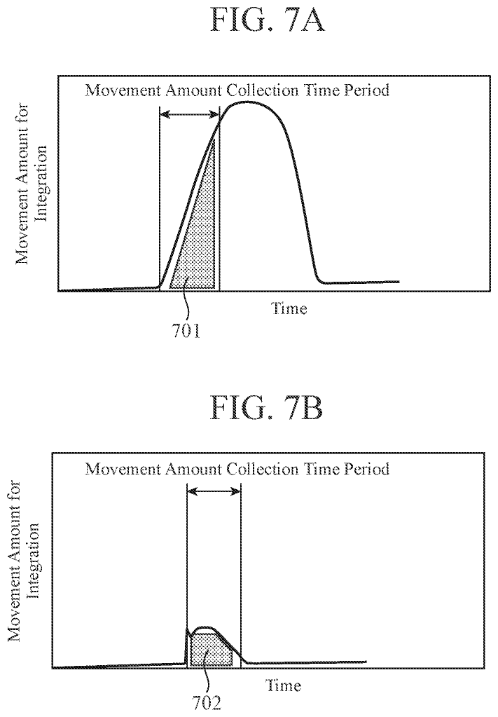

FIGS. 7A and 7B are diagrams for explaining a concept of the determination in Embodiment 1 of whether or not a push of the touch panel 14 is caused by a pushing operation, the determination being performed by the pushing determination unit 103 using the movement amount for determination.

FIG. 7A shows a concept of the movement amount for integration which varies with time when a push of the touch panel 14 occurs through a pushing operation. FIG. 7B shows a concept of the movement amount for integration which varies with time when there occurs a push of the touch panel 14 which is not caused by a pushing operation.

When a user performs a pushing operation, the movement amount for integration varies with time as shown by a curve shown in FIG. 7A. In FIG. 7A, the movement amount for determination within the movement amount collection time period is expressed by the area of a graphic 701.

When a user performs a pushing operation, it is estimated that the movement amount for determination is equal to or greater than the threshold for pushing determination. In other words, it is estimated that the area of the graphic 701 is equal to or greater than the threshold for pushing determination.

The pushing determination unit 103 can prevent the erroneous detection of a pushing operation by detecting a pushing operation on the basis of the determination that the movement amount for determination within the movement amount collection time period is equal to or greater than the threshold for pushing determination.

In contrast, when, for example, a push of the touch panel 14 occurs but this push is one which is not intended by a user and which is caused by a vibration of the vehicle or the like rather than by a pushing operation, the movement amount for integration varies with time as shown by a curve shown in FIG. 7B. In FIG. 7B, the movement amount for determination within the movement amount collection time period is expressed by the area of a graphic 702.

When there occurs a push of the touch panel 14 not intended by a user, it is estimated that the load applied to the touch panel 14 is smaller than that applied to the touch panel 14 by a pushing operation.

Therefore, it is estimated that the movement amount for determination is less than the threshold for pushing determination. In other words, it is estimated that the area of the graphic 702 is smaller than the threshold for pushing determination.

The pushing determination unit 103 can prevent a push of the touch panel 14 not intended by a user from being erroneously detected as a pushing operation by determining that the push of the touch panel 14 is not caused by a pushing operation on the basis of the determination that the movement amount for determination within the movement amount collection time period is less than the threshold for pushing determination.

When the pushing detection information is outputted from the pushing determination unit 103, the output unit 104 outputs the pushing detection information to, for example, the not-illustrated control device which the electronic device 1000 has.

The operation of the pushing detection device 100 according to Embodiment 1 will be explained.

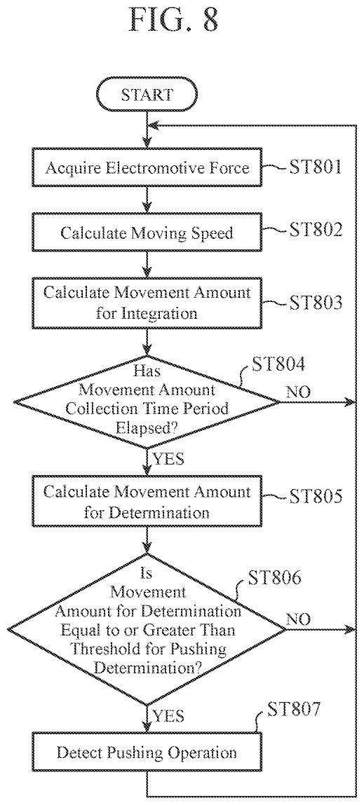

FIG. 8 is a flowchart for explaining the operation of the pushing detection device 100 according to Embodiment 1.

The electromotive force acquisition unit 101 acquires information about the electromotive force measured by the voltage measurement circuit 28 and occurring in the coil 23 (step ST801).

The electromotive force acquisition unit 101 outputs the acquired information about the electromotive force to the movement amount calculation unit 102.

The moving speed calculation unit 1021 of the movement amount calculation unit 102 calculates the moving speed of the coil unit 20A when a push occurs on the touch panel 14 from the information about the electromotive force which the electromotive force acquisition unit 101 acquires in step ST801 (step ST802).

The moving speed calculation unit 1021 outputs information about the calculated moving speed to the movement amount for integration calculation unit 1022 of the movement amount calculation unit 102.

The movement amount for integration calculation unit 1022 calculates the movement amount for integration of the coil unit 20A from the moving speed which the moving speed calculation unit 1021 calculates in step ST802 (step ST803).

The movement amount for integration calculation unit 1022 causes the calculated movement amount for integration to be temporarily stored in an area to which the movement amount calculation unit 102 can refer.

The movement amount for determination calculation unit 1023 of the movement amount calculation unit 102 determines whether or not the movement amount collection time period has elapsed (step ST804).

While in step ST804 the movement amount for determination calculation unit 1023 determines that the movement amount collection time period has not elapsed (“NO” in step ST804), the processes of steps ST801 to ST803 are repeated, and thereby the movement amount for integration calculation unit 1022 performs the calculation and the temporary storage of the movement amount for integration.

When in step ST804 the movement amount for determination calculation unit 1023 determines that the movement amount collection time period has elapsed (“YES” in step ST804), the movement amount for determination calculation unit 1023 calculates the movement amount for determination of the coil unit 20A within the movement amount collection time period on the basis of the movement amounts for integration which are caused to be temporarily stored by the movement amount for integration calculation unit 1022 (step ST805).

The movement amount for determination calculation unit 1023 outputs the calculated movement amount for determination to the pushing determination unit 103.

The pushing determination unit 103 determines whether or not the push occurring on the touch panel 14 is caused by a pushing operation, using the movement amount for determination calculated, in step ST805, by the movement amount for determination calculation unit 1023. Concretely, the pushing determination unit 103 determines whether or not the movement amount for determination outputted from the movement amount for determination calculation unit 1023 is equal to or greater than the threshold for pushing determination (step ST806).

When in step ST806 the pushing determination unit 103 determines that the movement amount for determination is less than the threshold for pushing determination (“NO” in step ST806), the pushing determination unit 103 does not detect a touch operation on the touch panel 14 and returns to step ST801.

When in step ST806 the pushing determination unit 103 determines that the movement amount for determination is equal to or greater than the threshold for pushing determination (“YES” in step ST806), the pushing determination unit 103 determines that the push of the touch panel 14 is caused by a pushing operation, and detects this pushing operation (step ST807). The pushing determination unit 103 then outputs pushing detection information to the output unit 104.

When in step ST806 the pushing determination unit 103 detects a pushing operation and pushing detection information is outputted, the output unit 104 outputs the pushing detection information to, for example, the not-illustrated control device which the electronic device 1000 has. After that, the pushing detection device 100 returns to step ST801.

As previously explained, the pushing detection device 100 integrates, over the movement amount collection time period, the movement amounts of the coil unit 20A when the coil unit 20A moves, the movement amounts being calculated on the basis of electromotive forces occurring in the coil unit 20A as the coil unit 20A moves, to thereby calculate the movement amount for determination, and determines the existence or nonexistence of a pushing operation by using the movement amount for determination. Therefore, the pushing detection device 100 can prevent the erroneous detection of a pushing operation on the touch panel 14 in the electronic device 1000.

Further, in the pushing detection device 100, the voice coil actuator 20 has the function of vibrating the touch panel 14, and the function of detecting a push of the touch panel 14. Therefore, in the electronic device 1000, an actuator for vibrating the touch panel 14 and a sensor for detecting a push of the touch panel can be integrated using the voice coil actuator 20 without having to separately provide the actuator and the sensor. As a result, in the electronic device 1000, downsizing or cost reduction can be implemented as compared with an electronic device that needs an actuator for vibrating a touch panel 14, and a sensor for detecting a push of the touch panel provided separately.

Further, in input devices based on a conventional technology, which are typified by that of above-mentioned Patent Literature 1, while a voice coil is fixed to a touch panel, a magnetic circuit is supported by the touch panel via a suspension, for example. Therefore, in input devices based on a conventional technology, even if a user performs a pressing operation on the touch panel, a relative movement of the voice coil with respect to the magnetic circuit occurs only instantaneously. This means that in input devices based on a conventional technology, an electromotive force in the voice coil, the electromotive force being caused by a pressing operation, occurs only instantaneously.

In contrast with this, in the electronic device 1000 according to Embodiment 1, while the coil unit 20A is fixed to the touch panel 14, the magnetic circuit unit 20B is fixed to the body chassis 13. In addition, the electronic device 1000 is configured in such a way that the touch panel 14 and the coil unit 20A move relatively to the body chassis 13 through a user's pushing operation on the touch panel 14. With this configuration, in the electronic device 1000, at least while a user is performing a pushing operation on the touch panel 14, the coil unit 20A and the magnetic circuit unit 20B are moving relatively to each other from their initial positions. This means that in the electronic device 1000 an electromotive force in the coil 23, the electromotive force being caused by a pushing operation, occurs over a period of time long compared with those of conventional technologies. Therefore, the pushing detection device 100 according to Embodiment 1 can determine the existence or nonexistence of a pushing operation by using an electromotive force occurring in the coil 23 over a relatively long period of time while a pushing operation is being performed on the touch panel 14 of the electronic device 1000. As a result, the pushing detection device 100 does not detect, as a pushing operation on the touch panel 14, a push of the touch panel 14 which occurs because of, for example, a non-intended user's touch of the touch panel 14 caused by a vibration of the vehicle or the like, and thus the pushing detection device 100 can prevent the erroneous detection of a pushing operation on the touch panel 14 in the electronic device 1000.

Although in above-mentioned Embodiment 1, the electronic device 1000 includes only the single voice coil actuator 20, this is only an example. For example, in a case where the electronic device 1000 has a large screen, the electronic device 1000 can include multiple voice coil actuators 20.

For example, voice coil actuators 20 may be disposed at both right and left edge portions on the rear surface of the touch panel 14, and, in addition to these voice coil actuators, voice coil actuators may be disposed at both upper and lower edge portions on the rear surface of the touch panel 14. As an alternative, voice coil actuators 20 may be disposed at only both the upper and lower edge portions on the rear surface of the touch panel 14. The number and positions of voice coil actuators 20 can be adjusted as appropriate.

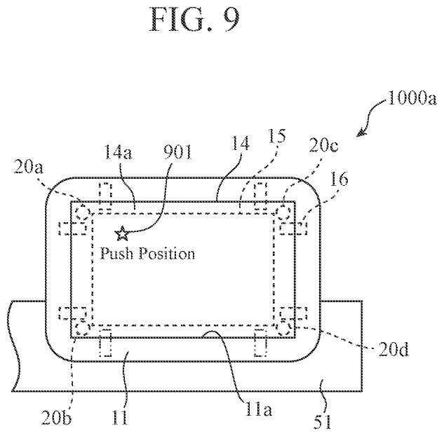

FIG. 9 is a diagram showing an example of the configuration of an electronic device 1000a in Embodiment 1 which is adapted to include multiple voice coil actuators 20. FIG. 9 is a front view of the electronic device 1000a, and the electronic device 1000a shown in FIG. 9 differs from the electronic device 1000 shown in FIG. 1 in that the electronic device 1000a includes multiple voice coil actuators 20.

As an example, the electronic device 1000a shown in FIG. 9 includes a voice coil actuator 20 at each of four corners of an edge portion on the rear surface of the touch panel 14. More specifically, the electronic device 1000a shown in FIG. 9 includes four voice coil actuators 20: a first voice coil actuator 20a, a second voice coil actuator 20b, a third voice coil actuator 20c, and a fourth voice coil actuator 20d. In the case where the electronic device 1000a includes the multiple voice coil actuators 20, the movement amount for integration and the movement amount for determination of the coil unit 20A of each voice coil actuator 20, which are calculated by the pushing detection device 100, differ depending on the push position on the touch panel 14.

Hereinafter, the movement amount for integration and the movement amount for determination of the coil unit 20A of each voice coil actuator 20 which differ depending on the push position on the touch panel 14 will be explained concretely.

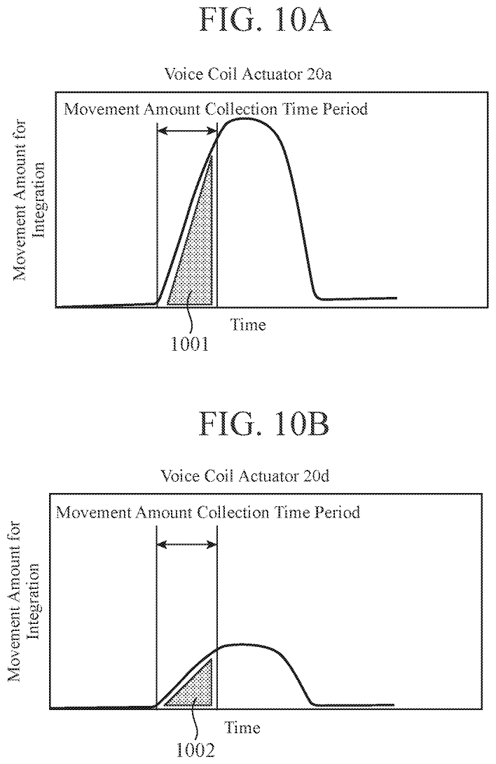

FIGS. 10A and 10B are diagrams for explaining a concept of the movement amount for determination which the pushing detection device 100 calculates in the case where the electronic device 1000a is the one as shown in FIG. 9 and where a push of the touch panel 14 occurs at a push position 901 in Embodiment 1.

FIG. 10A shows a concept of the movement amount for integration of the coil unit 20A in the first voice coil actuator 20a which varies with time when a push of the touch panel 14 occurs at the push position 901. FIG. 10B shows a concept of the movement amount for integration of the coil unit 20A in the fourth voice coil actuator 20d which varies with time when a push of the touch panel 14 occurs at the push position 901.

In FIG. 10A, the movement amount for determination is expressed by the area of a graphic 1001. In FIG. 10B, the movement amount for determination is expressed by the area of a graphic 1002.

The first voice coil actuator 20a is located at a position closer to the push position 901 than the fourth voice coil actuator 20d. Therefore, as shown in FIGS. 10A and 10B, the movement amount for determination of the coil unit 20A in the first voice coil actuator 20a is larger than the movement amount for determination of the coil unit 20A in the fourth voice coil actuator 20d.

In this way, the movement amount of the coil unit 20A of each voice coil actuator 20 which the pushing detection device 100 calculates when a push occurs on the touch panel 14 differs depending on the push position on the touch panel 14.

Therefore, in the pushing detection device 100, the pushing determination unit 103 determines whether or not a push of the touch panel 14 is caused by a pushing operation by using the threshold for pushing determination which the pushing determination unit sets up for each voice coil actuator 20 depending on the push position on the touch panel 14. The push position on the touch panel 14 can be detected using a general function which the touch panel 14 has. The pushing detection device 100 may acquire information about the push position from the touch panel 14.

The pushing determination unit 103 sets up the threshold for pushing determination for each voice coil actuator 20 depending on the distance to the push position on the touch panel 14. A concrete value of the threshold for pushing determination for the distance between the push position and each voice coil actuator 20 is predetermined. A relation between them is set up in such a way that the threshold for pushing determination becomes large as the distance between the push position and the voice coil actuator 20 becomes short.

In the pushing detection device 100, the pushing determination unit 103 determines, by using the threshold for pushing determination set up for each voice coil actuator 20, whether or not the movement amount for determination is equal to or greater than the threshold for pushing determination, thereby determining whether or not a push of the touch panel 14 is caused by a pushing operation. For example, when, as to all the voice coil actuators 20, the movement amount for determination is equal to or greater than the threshold for pushing determination, the pushing determination unit 103 determines that the push of the touch panel 14 is caused by a pushing operation. As an alternative, for example, when, as to half or more of all the voice coil actuators 20, the movement amount for determination is equal to or greater than the threshold for pushing determination, the pushing determination unit 103 may determine that the push of the touch panel 14 is caused by a pushing operation.

Further, although in the above example the pushing determination unit 103 determines whether or not a push is caused by a pushing operation as to the movement amounts for determination calculated for all the voice coil actuators 20, this is only an example. The pushing determination unit 103 may determine whether or not a push is caused by a pushing operation as to the movement amount(s) for determination calculated for one, two, or three of the four voice coil actuators 20.

As mentioned above, even in the case where the electronic device 1000a includes the multiple voice coil actuators 20, the pushing detection device 100 according to Embodiment 1 can prevent the erroneous detection of a pushing operation by determining whether or not a push occurring on the touch panel 14 is caused by a pushing operation by using the threshold for pushing determination set up depending on the distance between each voice coil actuator 20 and the push position.

Therefore, the pushing detection device 100 can properly determine whether or not a push occurring on the touch panel 14 is caused by a pushing operation also in the case of, for example, the electronic device 1000a having a large screen.

Even in the case where the number of voice coil actuators 20 included in the electronic device 1000 is one as shown in FIG. 1, the movement amount of the coil unit 20A calculated by the pushing detection device 100 may differ depending on the push position on the touch panel 14.

Therefore, also in the electronic device 1000 as shown in FIG. 1, the pushing determination unit 103 may set up the threshold for pushing determination depending on the distance from the voice coil actuator 20 to the push position on the touch panel 14.

Further, although above Embodiment 1 is based on the premise that the pushing detection device 100 is included in the electronic device 1000, the pushing detection device 100 may be disposed outside the electronic device 1000 and connected to the electronic device 1000 via a network.

Further, although in above Embodiment 1 the electronic device 1000 is a vehicle-mounted device, no limitation thereto is intended. The electronic device 1000 has only to include a touch panel.

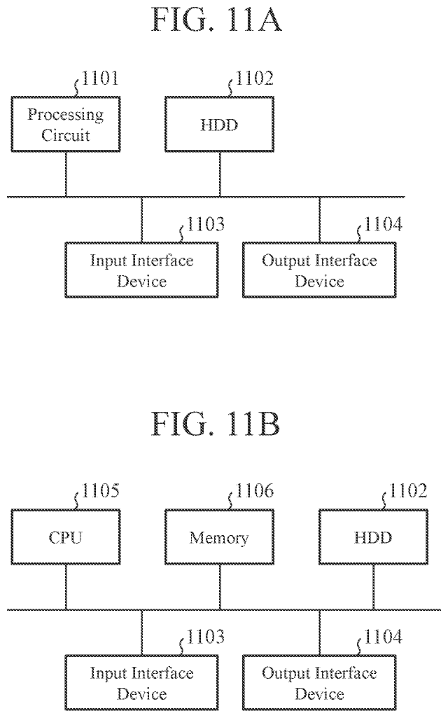

FIGS. 11A and 11B are diagrams showing examples of the hardware configuration of the pushing detection device 100 according to Embodiment 1.

In Embodiment 1, the functions of the electromotive force acquisition unit 101, the movement amount calculation unit 102, the pushing determination unit 103, and the output unit 104 are implemented by a processing circuit 1101. More specifically, the pushing detection device 100 includes the processing circuit 1101 for performing control to determine whether or not a push of the touch panel 14 is caused by a user's pushing operation.

The processing circuit 1101 may be hardware for exclusive use as shown in FIG. 11A or a central processing unit (CPU) 1105, as shown in FIG. 11B, which executes a program stored in a memory 1106.

In the case in which the processing circuit 1101 is hardware for exclusive use, the processing circuit 1101 is, for example, a single circuit, a composite circuit, a programmable processor, a parallel programmable processor, an application specific integrated circuit (ASIC), a field-programmable gate array (FPGA), or a combination thereof.

In the case where the processing circuit 1101 is the CPU 1105, the functions of the electromotive force acquisition unit 101, the movement amount calculation unit 102, the pushing determination unit 103, and the output unit 104 are implemented by software, firmware, or a combination of software and firmware. More specifically, the electromotive force acquisition unit 101, the movement amount calculation unit 102, the pushing determination unit 103, and the output unit 104 are implemented by the processing circuit like the CPU 1105 or a system large-scale integration (LSI) which executes a program stored in a hard disk drive (HDD) 1102, the memory 1106 or the like. Further, it can be said that the program stored in the HDD 1102, the memory 1106 or the like causes a computer to perform procedures or methods of the electromotive force acquisition unit 101, the movement amount calculation unit 102, the pushing determination unit 103, and the output unit 104. Here, the memory 1106 is, for example, a non-volatile or volatile semiconductor memory, such as a random access memory (RAM), a read only memory (ROM), a flash memory, an erasable programmable read only memory (EPROM), and an electrically erasable programmable read-only memory (EEPROM), a magnetic disc, a flexible disc, an optical disc, a compact disc, a mini disc, or a digital versatile disc (DVD).

Part of the functions of the electromotive force acquisition unit 101, the movement amount calculation unit 102, the pushing determination unit 103, and the output unit 104 may be implemented by hardware for exclusive use, and part of the functions may be implemented by software or firmware. For example, the functions of the electromotive force acquisition unit 101 and the output unit 104 can be implemented by the processing circuit 1101 as hardware for exclusive use, and the functions of the movement amount calculation unit 102 and the pushing determination unit 103 can be implemented by the processing circuit's reading and execution of a program stored in the memory 1106.

Further, the pushing detection device 100 includes an input interface device 1103 and an output interface device 1104 which perform cable communication or wireless communication with a device like the electronic device 1000 or 1000a.

As mentioned above, the pushing detection device 100 according to Embodiment 1 is configured in such a way as to include: the movement amount calculation unit 102 for integrating, over the movement amount collection time period, the movement amounts of the coil unit 20A when the coil unit 20A moves, the movement amounts being calculated on the basis of electromotive forces occurring in the coil unit 20A as the coil unit 20A moves, to thereby calculate the movement amount for determination of the coil unit 20A; and the pushing determination unit 103 for determining the existence or nonexistence of a pushing operation by using the movement amount for determination calculated by the movement amount calculation unit 102. Therefore, the pushing detection device 100 can prevent the erroneous detection of a pushing operation on the touch panel.

In the pushing detection device 100 according to Embodiment 1, the pushing determination unit 103 is configured in such away as to determine whether or not the movement amount for determination is equal to or greater than the threshold for pushing detection, and to, when the movement amount for determination is less than the threshold for pushing detection, determine that a push of the touch panel 14 is not caused by a pushing operation. The pushing detection device 100 can prevent the erroneous detection of a pushing operation by not detecting, as a push caused by a pushing operation, a push of the touch panel 14 which is assumed to be a push which no user intends to make.

Further, each of the electronic devices 1000 and 1000a according to Embodiment 1 is configured in such a way as to include the touch panel 14, the body chassis 13, and the voice coil actuator 20 for vibrating the touch panel 14, the voice coil actuator 20 having the coil unit 20A fixed to the touch panel 14 and the magnetic circuit unit 20B fixed to the body chassis 13, and in such a way that the touch panel 14 and the coil unit 20A move relatively to the body chassis 13 through a pushing operation on the touch panel 14. With this configuration, in the electronic device 1000, at least while a user is performing a pushing operation on the touch panel 14, the coil unit 20A and the magnetic circuit unit 20B are moving relatively to each other from their initial positions. This means that in the electronic device 1000, the electromotive force in the coil 23 caused by a pushing operation lasts long compared with those in conventional technologies. Therefore, the pushing detection device 100 according to Embodiment 1 can determine the existence or nonexistence of a pushing operation by using an electromotive force occurring over a relatively long period of time in the coil 23 while a pushing operation is being performed on the touch panel 14 of the electronic device 1000. As a result, the pushing detection device 100 does not detect, as a pushing operation on the touch panel 14, a push of the touch panel 14 which occurs because of, for example, a non-intended user's touch of the touch panel 14 caused by a vibration of the vehicle or the like, and thus the pushing detection device 100 can prevent the erroneous detection of a pushing operation on the touch panel 14 in the electronic device 1000.

It is to be understood that various changes can be made in any component according to the embodiment or any component according to the embodiment can be omitted within the scope of the present disclosure.

### INDUSTRIAL APPLICABILITY

Because the pushing detection device for touch panel according to the present disclosure is configured in such away as to be able to prevent the erroneous detection of a pushing operation on a touch panel, the pushing detection device can be applied to a pushing detection device for touch panel which detects a pushing operation on a touch panel in an electronic device in which the touch panel is supported in such a way that the touch panel can vibrate.

### REFERENCE SIGNS LIST

11 front side design panel, 11a opening, 12 rear side design panel, 13 body chassis, 13a through hole, 14 touch panel, 14a operation surface, 15 liquid crystal panel, 16 spring, 17, 18 screw, 20 voice coil actuator, 20a first voice coil actuator, 20b second voice coil actuator, 20c third voice coil actuator, 20d fourth voice coil actuator, 20A coil unit, 20B magnetic circuit unit, 21 pusher, 22 coil bobbin, 23 coil, 24 yoke, 25 pole, 26 magnet, 27 magnetic gap, 28 voltage measurement circuit, 51 vehicle panel, 52 mounting plate, 53 vehicle side fixed portion, 100 pushing detection device, 101 electromotive force acquisition unit, 102 movement amount calculation unit, 1021 moving speed calculation unit, 1022 movement amount for integration calculation unit, 1023 movement amount for determination calculation unit, 103 pushing determination unit, 104 output unit, and 1000, 1000a electronic device.

1. A pushing detection device for touch panel, for detecting a pushing operation on a touch panel in an electronic device which includes the touch panel, a body chassis, and at least one voice coil actuator for vibrating the touch panel, the voice coil actuator having a coil unit fixed to the touch panel and a magnetic circuit unit fixed to the body chassis, and in which the touch panel and the coil unit move relatively to the body chassis through the pushing operation on the touch panel, the pushing detection device comprising:
processing circuitry
to integrate, over a movement amount collection time period, a movement amount of the coil unit when the coil unit moves, the movement amount being calculated on a basis of an electromotive force occurring in the coil unit as the coil unit moves, to thereby calculate a movement amount for determination of the coil unit; and
to determine existence or nonexistence of the pushing operation by using the calculated movement amount for determination.

2. The pushing detection device for touch panel according to claim 1, wherein the processing circuitry
calculates a moving speed of the coil unit when the coil unit moves, on a basis of the electromotive force occurring in the coil unit as the coil unit moves;
integrates the calculated moving speed, to thereby calculate, as a movement amount for integration, the movement amount of the coil unit every time a predetermined time elapses; and
integrates, over the movement amount collection time period, the calculated movement amount for integration, to thereby calculate the movement amount for determination.

3. The pushing detection device for touch panel according to claim 1, wherein the processing circuitry determines whether or not the movement amount for determination is equal to or greater than a threshold for pushing determination, and determines that the movement of the coil unit is not caused by a pushing operation on the touch panel when the movement amount for determination is less than the threshold for pushing determination.

4. The pushing detection device for touch panel according to claim 3, wherein the at least one voice coil actuator including multiple voice coil actuators are included in the electronic device, and
the threshold for pushing determination is set up for each of the multiple voice coil actuators depending on a distance between a corresponding one of the multiple voice coil actuators and a position of a pushing operation on the touch panel.

5. An electronic device comprising:
the pushing detection device for touch panel according to claim 1;
the touch panel;
the body chassis; and
the voice coil actuator.

6. An electronic device comprising:
a touch panel;
a body chassis; and
a voice coil actuator for vibrating the touch panel, the voice coil actuator having a coil unit fixed to the touch panel and a magnetic circuit unit fixed to the body chassis,
wherein the touch panel and the coil unit move relatively to the body chassis through a pushing operation on the touch panel.

7. A pushing detection method for touch panel, of detecting a pushing operation on a touch panel in an electronic device which includes the touch panel, a body chassis, and at least one voice coil actuator for vibrating the touch panel, the voice coil actuator having a coil unit fixed to the touch panel and a magnetic circuit unit fixed to the body chassis, and in which the touch panel and the coil unit move relatively to the body chassis through the pushing operation on the touch panel, the pushing detection method comprising:
integrating, over a movement amount collection time period, a movement amount of the coil unit when the coil unit moves, the movement amount being calculated on a basis of an electromotive force occurring in the coil unit as the coil unit moves, to thereby calculate a movement amount for determination of the coil unit; and
determining existence or nonexistence of the pushing operation by using the calculated movement amount for determination.
